(19) United States
(12) Patent Application Publication
(10) Pub. No.: US 2014/0179858 A1
(43) Pub. Date: Jun. 26, 2014

(54) Phosphorous Copolymer, Method for Preparing the Same, and Flame Retardant Thermoplastic Resin Composition Including the Same

(71) Applicant: Cheil Industries Inc., Gumi-si (KR)

(72) Inventors: Seung Woo JANG, Uiwang-si (KR); Chang Hong KO, Uiwang-si (KR)

(73) Assignee: Cheil Industries Inc., Gumi-si (KR)

(21) Appl. No.: 13/948,414

(22) Filed: Jul. 23, 2013

(30) Foreign Application Priority Data
Dec. 20, 2012 (KR) 10-2012-0150062

(51) Int. Cl. C08G 79/04; C08L 9/06

(52) U.S. Cl. CPC C08G 79/04; C08L 9/06
USPC 524/540; 528/169; 525/534; 525/150; 525/461; 525/420; 525/146

(57) ABSTRACT

A phosphorous copolymer, a method for preparing the same, and a flame retardant thermoplastic resin composition including the same is disclosed. The phosphorous copolymer includes a repeat unit represented by Formula 1:

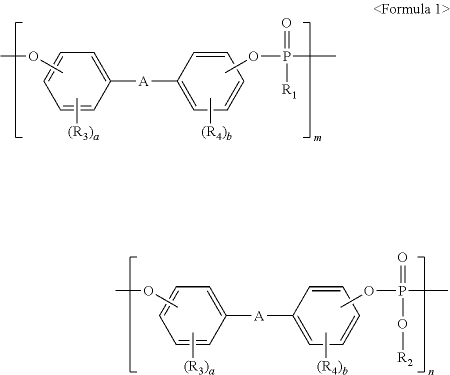

wherein each A is independently a single bond, C₁ to C₅ alkylene, C₁ to C₅ alkylidene, C₅ to C₆ cycloalkylidene, —S—, or —SO₂—; R₁ and R₂ are each independently substituted or unsubstituted C₁ to C₆ alkyl or substituted or unsubstituted C₆ to C₂₀ aryl; R₃ and R₄ are each independently substituted or unsubstituted C₁ to C₆ alkyl, substituted or unsubstituted C₃ to C₆ cycloalkyl, substituted or unsubstituted C₆ to C₁₂ aryl, or halogen; a and b are each independently an integer from 0 to 4; and m and n are each independently an integer from 1 to 500.

### CROSS-REFERENCE TO RELATED APPLICATION

This application claims priority under 35 USC Section 119 to and the benefit of Korean Patent Application No. 10-2012-0150062, filed Dec. 20, 2012, the entire disclosure of which is incorporated herein by reference.

### FIELD OF THE INVENTION

The present invention relates to a phosphorous copolymer, a method for preparing the same, and a flame retardant thermoplastic resin composition including the same.

### BACKGROUND OF THE INVENTION

With increasing interest in environmental problems, regulations regarded existing halogen flame retardants have been gradually strengthened throughout the world. Thus, active studies have been made to develop non-halogen flame retardants, particularly, phosphorous flame retardants.

In the art, phosphate ester is most widely used as a phosphorous flame retardant, and monomolecular type phosphorous flame retardants, such as triphenyl phosphate and resorcinol bisphenol phosphate, are mainly used. However, such a monomolecular type phosphorous flame retardant has a low molecular weight and is volatilized at high temperature upon plastic molding, causing deterioration in external appearance of the plastics. Moreover, when used in various products, the monomolecular type phosphorous flame retardant may escape into the environment, causing environmental pollution.

Accordingly, polymerizable phosphorous flame retardants capable of overcoming such problems have attracted attention. A polymeric polyphosphonate can be superior to monomolecular type phosphorous flame retardants in terms of flame retardancy, mechanical properties, heat resistance, and transparency, and can be thus suited for use with various thermoplastic resins requiring such properties.

However, when added to thermoplastic resins, polyphosphonate developed in the art can be unsatisfactory in terms of impact strength, heat resistance, and external appearance, and can decompose the thermoplastic resins due to structural characteristics thereof, causing property deterioration. Moreover, the existing polyphosphonate can have insufficient compatibility with resins and poor dispersibility.

### SUMMARY OF THE INVENTION

The present invention provides a phosphorous copolymer including both a phosphonate unit and a phosphate unit that can exhibit excellent flame retardancy and heat resistance, a method for preparing the same, an eco-friendly flame retardant thermoplastic resin composition which employs the same as a flame retardant and can exhibit excellent properties in terms of flame retardancy, heat resistance and transparency, and a molded article formed of the resin composition.

The invention relates to a phosphorous copolymer. The phosphorous copolymer includes a repeat unit represented by Formula 1:

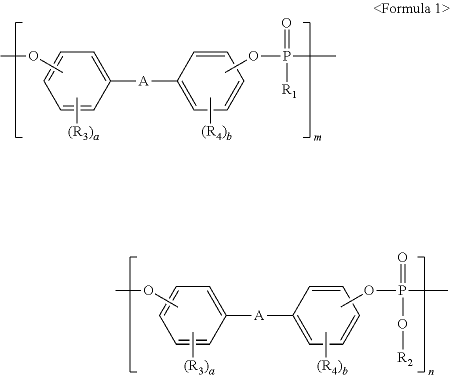

wherein each A is the same or different and is each independently a single bond, C₁ to C₅ alkylene, C₁ to C₅ alkylidene, C₅ to C₆ cycloalkylidene, —S—, or —SO₂—;

R₁ and R₂ are the same or different and are each independently substituted or unsubstituted C₁ to C₆ alkyl or substituted or unsubstituted C₆ to C₂₀ aryl;

R₃ and R₄ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen;

a and b are the same or different and are each independently an integer from 0 to 4; and

m and n are the same or different and are each independently an integer from 1 to 500.

In one embodiment, a ratio of the m repeat units to the n repeat units (m:n) may be about 1: about 0.1 to about 1: about 10.

In one embodiment, the phosphorous copolymer may have a weight average molecular weight from about 1,000 g/mol to about 50,000 g/mol.

In one embodiment, the phosphorous copolymer may have a glass transition temperature from about 60° C. to about 200° C.

The invention also relates to a method for preparing the phosphorous copolymer. The method includes: reacting a phosphonic dichloride compound represented by Formula 2, a dichlorophosphate compound represented by Formula 3, and a diol compound represented by Formula 4.

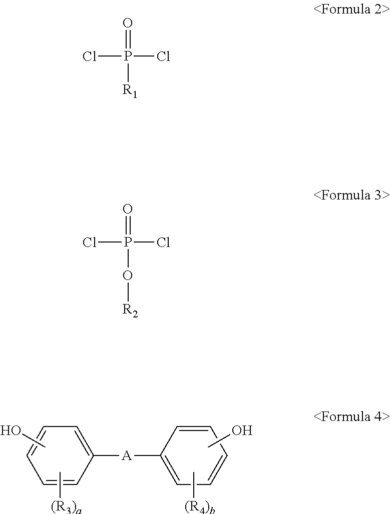

In Formulas 2 to 4, A, R₁, R₂, R₃, R₄, a and b are the same as defined in Formula 1.

In one embodiment, about 1 weight equivalent of the phosphonic dichloride compound represented by Formula 2 and the dichlorophosphate compound represented by Formula 3 may be reacted with about 0.5 weight equivalent to about 2 weight equivalent of the diol compound represented by Formula 4.

In one embodiment, a molar ratio of the phosphonic dichloride compound represented by Formula 2 to the dichlorophosphate compound represented by Formula 3 may be about 1: about 0.1 to about 1: about 10.

The invention further relates to a flame retardant thermoplastic resin composition. The flame retardant thermoplastic resin composition includes a thermoplastic resin, and a phosphorous copolymer including a repeat unit represented by Formula 1.

In one embodiment, the phosphorous copolymer may be present in an amount of about 0.1 parts by weight to about 40 parts by weight based on about 100 parts by weight of the thermoplastic resin.

In one embodiment, the thermoplastic resin may include at least one of aromatic vinyl resins, polyphenylene ether resins, polycarbonate resins, acrylic resins, polyamide resins, and polyolefin resins.

The thermoplastic resin may include about 50% by weight (wt %) to about 99 wt % of an aromatic vinyl resin, and about 1 wt % to about 50 wt % of a polyphenylene ether resin.

The thermoplastic resin may include about 5 wt % to about 95 wt % of a polycarbonate resin, and about 5 wt % to about 95 wt % of an aromatic vinyl resin.

The aromatic vinyl resin may be a rubber-modified aromatic vinyl resin.

In one embodiment, the flame retardant thermoplastic resin composition may further include at least one additive selected from the group consisting of flame retardant aids, lubricants, plasticizers, heat stabilizers, anti-dripping agents, antioxidants, compatibilizers, photostabilizers, pigments, dyes, and combinations thereof.

In one embodiment, the flame retardant thermoplastic resin composition may have a flame retardancy level of V-0 or higher, as measured according to the UL-94 vertical flammability test method, and a Vicat softening temperature (VST) of about 100° C. to about 140° C.

The invention further relates to a molded article formed of the flame retardant thermoplastic resin composition.

### BRIEF DESCRIPTION OF THE DRAWING

FIG. 1 is an NMR spectrum of a phosphorous copolymer prepared in Example 1.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

In accordance with one embodiment, a phosphorous copolymer includes a repeat unit represented by Formula 1.

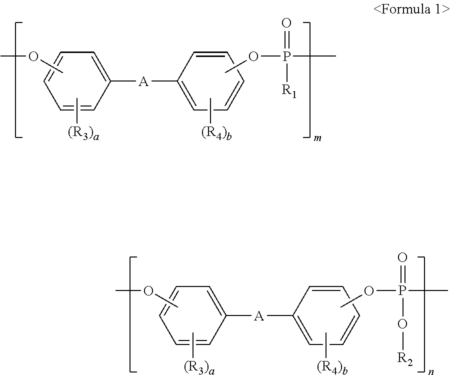

In Formula 1,

each A is the same or different and is each independently a single bond, C₁ to C₅ alkylene, C₁ to C₅ alkylidene, C₅ to C₆ cycloalkylidene, —S—, or —SO₂—;

R₁ and R₂ are the same or different and are each independently substituted or unsubstituted C₁ to C₆ alkyl or substituted or unsubstituted C₆ to C₂₀ aryl;

R₃ and R₄ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen;

a and b are the same or different and are each independently an integer from 0 to 4; and

m and n are the same or different and are each independently an integer from 1 to 500, for example an integer from 4 to 500.

Here, the term “substituted” means that a hydrogen atom is substituted with a substituent group including halogen, C₁ to C₃₀ alkyl, C₁ to C₃₀ haloalkyl, C₆ to C₃₀ aryl, C₂ to C₃₀ heteroaryl, C₁ to C₂₀ alkoxy, or a combination thereof. As used herein, the term hetero refers to one or more carbon atoms replaced with O, N, S, P, or a combination thereof.

In one embodiment, a ratio of the m repeat units to the n repeat units (m:n) may be about 1: about 0.1 to about 1: about 10, for example about 1: about 0.3 to about 1: about 3. Within this range, the phosphorous copolymer can exhibit excellent flame retardancy.

The phosphorous copolymer may have a weight average molecular weight (Mw) from about 1,000 g/mol to 50,000 g/mol, as measured by gel permeation chromatography (GPC), for example from about 1,500 g/mol to 10,000 g/mol. Within this range, the phosphorous copolymer can exhibit excellent flame retardancy.

The phosphorous copolymer may have a glass transition temperature from about 60° C. to about 200° C.

In accordance with one embodiment, a method for preparing the phosphorous copolymer includes the step of reacting a phosphonic dichloride compound represented by Formula 2, a dichlorophosphate compound represented by Formula 3, and a diol compound represented by Formula 4.

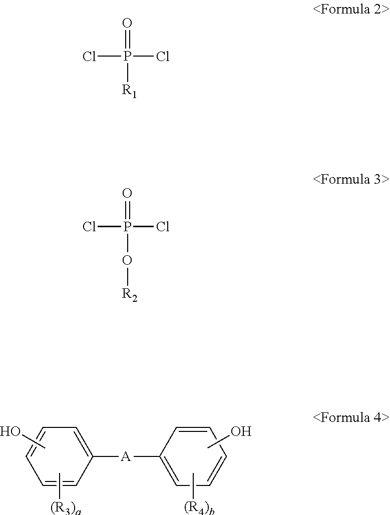

In Formulas 2 to 4, A, R₁, R₂, R₃, R₄, a and b are the same as defined in Formula 1.

Examples of the diol compound represented by Formula 4 include without limitation 4,4′-dihydroxybiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like. These compounds can be used alone or in combination thereof.

In one embodiment, reaction of the phosphonic dichloride compound, the dichlorophosphate compound and the diol compound may be performed by dropwise addition of the phosphonic dichloride compound and the dichlorophosphate compound to a mixture of the diol compound, a catalyst and an end-capping agent, wherein about 1 weight equivalent of the phosphonic dichloride compound and the dichlorophosphate compound may be reacted with about 0.5 weight equivalent to about 2 weight equivalent of the diol compound represented by Formula 4, for example, about 1 weight equivalent of the diol compound.

Here, a molar ratio of the phosphonic dichloride compound to the dichlorophosphate compound may be about 1: about 0.1 to about 1: about 10, for example about 1: about 0.3 to about 1: about 3. Within this range, the phosphorous copolymer can exhibit excellent flame retardancy.

Reaction of the phosphonic dichloride compound, the dichlorophosphate compound and the diol compound may be performed by any typical polymerization method in the presence of a Lewis acid catalyst. Solution polymerization can be the polymerization method. As the Lewis acid catalyst, aluminium chloride, magnesium chloride, and the like and combinations thereof may be used, without being limited thereto. Relative to about 1 weight equivalent of the total diol compound, the catalyst may be added in an amount of about 0.01 weight equivalent to about 10 weight equivalent, for example about 0.01 weight equivalent to about 1 weight equivalent, and as another example about 0.01 weight equivalent to about 0.1 weight equivalent.

In addition, the reaction may be performed in the presence of an end-capping agent. The end-capping agent may employ a C₁ to C₅ alkyl group-containing phenol, such as phenol, 4-t-butyl phenol, 2-t-butyl phenol, and the like, and combinations thereof. Relative to about 1 weight equivalent of the total diol compound, the end-capping agent may be added in an amount of about 1 weight equivalent or less, for example about 0.01 weight equivalent to about 0.5 weight equivalent.

In one embodiment, after the reaction, the resultant may be washed with an acid solution. The acid solution may include phosphoric acid, hydrochloric acid, nitric acid, and sulfuric acid, and the like, and combinations thereof, for example phosphoric acid and/or hydrochloric acid. Here, the acid solution may have a concentration of about 0.1% to about 10%, for example about 1% to about 5%. After washing and filtering the resultant, the phosphorous copolymer may be obtained as a white solid.

In accordance with one embodiment, a flame retardant thermoplastic resin composition includes a thermoplastic resin and the phosphorous copolymer as a flame retardant. The flame retardant thermoplastic resin composition may include the phosphorous copolymer in an amount of about 0.1 parts by weight to about 40 parts by weight, for example about 0.5 parts by weight to about 30 parts by weight, and as another example about 1 part by weight to about 25 parts by weight, based on about 100 parts by weight of the thermoplastic resin. In some embodiments, the flame retardant thermoplastic resin composition may include the phosphorous copolymer in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight. Further, according to some embodiments of the present invention, the amount of the phosphorous copolymer can be in a range from about any of the foregoing amounts to about any other of the foregoing amounts.

When the flame retardant thermoplastic resin composition includes the phosphorous copolymer in an amount within this range, the flame retardant thermoplastic resin composition can exhibit excellent flame retardancy, heat resistance, transparency, property balance, and the like.

As the thermoplastic resin, any typical thermoplastic resin may be used without limitation. Examples of the thermoplastic resin include without limitation aromatic vinyl resins, polyphenylene ether resins, polycarbonate resins, acrylic resins, polyamide resins, polyolefin resins, and the like. These resins may be used alone or in combination thereof.

In one embodiment, the thermoplastic resin may include aromatic vinyl resin in an amount of about 50 wt % to about 99 wt %, for example about 50 wt % to about 80 wt %, and polyphenylene ether resin in an amount of about 1 wt % to about 50 wt %, for example about 20 wt % to about 50 wt %.

In some embodiments, the thermoplastic resin may include aromatic vinyl resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of the aromatic vinyl resin can be in a range from about any of the foregoing amounts to about any other of the foregoing amounts.

In some embodiments, the thermoplastic resin may include polyphenylene ether resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the polyphenylene ether resin can be in a range from about any of the foregoing amounts to about any other of the foregoing amounts.

When the thermoplastic resin includes aromatic vinyl resin and polyphenylene ether resin in amounts within the above ranges, the flame retardant thermoplastic resin composition can have a good balance of properties, such as flame retardancy, heat resistance, and the like.

In another embodiment, the thermoplastic resin may include polycarbonate resin in an amount of about 5 wt % to about 95 wt %, for example about 70 wt % to about 90 wt %, and aromatic vinyl resin, for example, rubber-modified aromatic vinyl resin, in an amount of about 5 wt % to about 95 wt %, for example about 10 wt % to about 30 wt %.

In some embodiments, the thermoplastic resin may include polycarbonate resin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the polycarbonate resin can be in a range from about any of the foregoing amounts to about any other of the foregoing amounts.

In some embodiments, the thermoplastic resin may include aromatic vinyl resin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the aromatic vinyl resin can be in a range from about any of the foregoing amounts to about any other of the foregoing amounts.

When the thermoplastic resin includes polycarbonate resin and aromatic vinyl resin in an amount within the above ranges, the composition can have a good balance of properties such as flame retardancy, heat resistance, and the like.

Hereinafter, among the thermoplastic resins applicable to the invention, the aromatic vinyl resin, the polyphenylene ether resin and the polycarbonate resin will be described in more detail.

Aromatic Vinyl Resin

The aromatic vinyl resin may be a polymer of one or more aromatic vinyl monomers (aromatic vinyl polymer resin); a copolymer of an aromatic vinyl monomer and another monomer copolymerizable with the aromatic vinyl monomer (an aromatic vinyl copolymer); a rubber-modified aromatic vinyl copolymer including a rubbery polymer dispersed in pellet form in a matrix (continuous phase) including the aromatic vinyl polymer, and the like. For example, the rubber-modified aromatic vinyl copolymer may be polymerized by adding an aromatic vinyl monomer and optionally adding another monomer, copolymerizable with the aromatic vinyl monomer, to a rubbery polymer.

Generally, the rubber-modified aromatic vinyl copolymer may be prepared by any polymerization method known in the art, such as emulsion polymerization, suspension polymerization, and mass polymerization, and typically, may be prepared using a (rubber-modified) graft copolymer alone, or using a mixture of a graft copolymer and the aromatic vinyl copolymer. For example, the rubber-modified aromatic vinyl copolymer may be prepared by mixing and extruding these two copolymers. Here, when using the mixture of the graft copolymer and the aromatic vinyl copolymer, these two copolymers may be mixed in consideration of compatibility. In addition, in mass polymerization, the rubber-modified aromatic vinyl copolymer may be prepared through single-stage reaction without separately preparing the graft copolymer and the aromatic vinyl copolymer. In either case, a rubber (rubbery polymer) may be present in an amount of about 5 wt % to about 50 wt % in the final rubber-modified aromatic vinyl copolymer. Further, the rubber may have a z-average particle size from about 0.05 μm to about 6.0 μm. Within this range, the flame retardant thermoplastic resin composition can exhibit excellent properties in terms of impact resistance, and the like.

In exemplary embodiments, the graft copolymer may be obtained by graft copolymerization of a rubbery polymer, an aromatic vinyl monomer, and a monomer copolymerizable with the aromatic vinyl monomer, and may further include a monomer imparting processability and heat resistance, as needed.

Examples of the rubbery polymer include without limitation diene rubbers such as polybutadiene, poly(styrene-butadiene), poly(acrylonitrile-butadiene), and the like; saturated rubbers obtained by adding hydrogen to the diene rubbers; isoprene rubbers; acrylic rubbers such as poly(butyl acrylate); ethylene-propylene-diene monomer (EPDM) terpolymers, and the like, and combinations thereof. In exemplary embodiments, the rubbery polymer can include a diene rubber, for example a butadiene rubber.

The graft copolymer can include the rubbery polymer in an amount of about 5 wt % to about 65 wt %, for example about 10 wt % to about 60 wt %, and as another example about 20 wt % to about 50 wt %, based on the total weight of the graft copolymer. In some embodiments, the graft copolymer may include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt %. Further, according to some embodiments of the present invention, the amount of the rubbery polymer can be in a range from about any of the foregoing amounts to about any other of the foregoing amounts.

Within this range, the composition can have an excellent balance between impact strength and mechanical properties.

The rubbery polymer (rubbery particles) may have an average (z-average) particle size from about 0.05 μm to about 6 μm, for example from about 0.15 μm to about 4 μm, and as another example from about 0.25 μm to about 3.5 μm. Within this range, the flame retardant thermoplastic resin composition can exhibit excellent impact strength and appearance.

The aromatic vinyl monomer may be an aromatic vinyl monomer capable of being grafted to the rubbery copolymer. Examples of the aromatic vinyl monomer capable of being grafted to the rubbery copolymer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and combinations thereof. In exemplary embodiments, the aromatic vinyl monomer can include styrene.

The graft copolymer can include the aromatic vinyl monomer in an amount of about 15 wt % to about 94 wt %, for example about 20 wt % to about 80 wt %, and as another example about 30 wt % to about 60 wt %, based on the total weight of the graft copolymer. In some embodiments, the graft copolymer may include the aromatic vinyl monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94 wt %. Further, according to some embodiments of the present invention, the amount of the aromatic vinyl monomer can be in a range from about any of the foregoing amounts to about any other of the foregoing amounts.

Within this range, the flame retardant thermoplastic resin composition can have an excellent balance between impact strength and mechanical properties.

Examples of the monomer copolymerizable with the aromatic vinyl monomer may include without limitation vinyl cyanide compounds such as acrylonitrile; unsaturated nitriles such as ethacrylonitrile, methacrylonitrile, and the like. These monomers may be used alone or in combination thereof.

The graft copolymer may include the monomer copolymerizable with the aromatic vinyl monomer in an amount of about 1 wt % to about 50 wt %, for example about 5 wt % to about 45 wt %, and as another example about 10 wt % to about 30 wt %, based on the total weight of the graft copolymer. In some embodiments, the graft copolymer may include the monomer copolymerizable with the aromatic vinyl monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the monomer copolymerizable with the aromatic vinyl monomer can be in a range from about any of the foregoing amounts to about any other of the foregoing amounts.

Within this range, the flame retardant thermoplastic resin composition can have balance of excellent impact strength and mechanical properties.

Examples of the monomer for imparting processability and heat resistance may include without limitation acrylic acid, methacrylic acid, maleic anhydride, N-substituted maleimide, and the like, and combinations thereof.

The graft copolymer can optionally include the monomer for imparting processability and heat resistance in an amount of about 15 wt % or less, for example from about 0.1 wt % to about 10 wt %, based on the total weight of the graft copolymer. In some embodiments, the graft copolymer may include the monomer for imparting processability and heat resistance in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 wt %. Further, according to some embodiments of the present invention, the amount of the monomer for imparting processability and heat resistance can be in a range from about any of the foregoing amounts to about any other of the foregoing amounts.

Within this range, the monomer can impart processability and heat resistance to the flame retardant thermoplastic resin composition without deteriorating other properties.

The aromatic vinyl copolymer may be prepared using a mixture of the monomers, excluding the rubber (rubbery polymer) among components of the graft copolymer, and the ratio of the monomers may vary depending on compatibility, and the like. For example, the aromatic vinyl copolymer may be obtained by copolymerization of the aromatic vinyl monomer and the monomer copolymerizable with the aromatic vinyl monomer.

Examples of the aromatic vinyl monomer include without limitation styrene, α-methylstyrene, β-methylstyrene, p-methylstyrene, p-t-butylstyrene, ethylstyrene, vinylxylene, monochlorostyrene, dichlorostyrene, dibromostyrene, and vinyl naphthalene, and the like, and combinations thereof. In exemplary embodiments, the aromatic vinyl monomer can include styrene.

In addition, examples of the monomer copolymerizable with the aromatic vinyl monomer include without limitation vinyl cyanide compounds such as acrylonitrile; unsaturated nitriles such as ethacrylonitrile, methacrylonitrile, and the like. These monomers may be used alone or in combination thereof.

The aromatic vinyl copolymer may further include the monomer for imparting processability and heat resistance, as needed. Examples of the monomer for imparting processability and heat resistance include without limitation acrylic acid, methacrylic acid, maleic anhydride, N-substituted maleimide, and the like, and combinations thereof.

The aromatic vinyl copolymer may include the aromatic vinyl monomer in an amount of about 50 wt % to about 95 wt %, for example about 60 wt % to about 90 wt %, and as another example about 70 wt % to about 80 wt %, based on the total weight of the aromatic vinyl copolymer. In some embodiments, the aromatic vinyl copolymer may include the aromatic vinyl monomer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of the aromatic vinyl monomer can be in a range from about any of the foregoing amounts to about any other of the foregoing amounts.

Within this range, the flame retardant thermoplastic resin composition can have an excellent balance of impact strength and mechanical properties.

The aromatic vinyl copolymer may include the monomer copolymerizable with the aromatic vinyl monomer in an amount of about 5 wt % to about 50 wt %, for example about 10 wt % to about 40 wt %, and as another example about 20 wt % to about 30 wt %, based on the total weight of the aromatic vinyl copolymer. In some embodiments, the graft copolymer may include the monomer copolymerizable with the aromatic vinyl monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the monomer copolymerizable with the aromatic vinyl monomer can be in a range from about any of the foregoing amounts to about any other of the foregoing amounts.

Within this range, the flame retardant thermoplastic resin composition can have an excellent balance of impact strength and mechanical properties.

In addition, aromatic vinyl copolymer may optionally include the monomer for imparting processability and heat resistance in an amount of about 30 wt % or less, for example about 0.1 wt % to about 20 wt %, based on the total weight of the aromatic vinyl copolymer. In some embodiments, the graft copolymer may include the monomer for imparting processability and heat resistance in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 wt %. Further, according to some embodiments of the present invention, the amount of the monomer for imparting processability and heat resistance can be in a range from about any of the foregoing amounts to about any other of the foregoing amounts.

Within this range, the monomer can impart processability and heat resistance to the flame retardant thermoplastic resin composition without deteriorating other properties.

The aromatic vinyl copolymer may have a weight average molecular weight of about 30,000 g/mol to about 500,000 g/mol, without being limited thereto.

Examples of the rubber-modified aromatic vinyl copolymer may include without limitation acrylonitrile-butadiene-styrene (ABS) copolymers, acrylonitrile-ethylene-propylene rubber-styrene (AES) copolymers, acrylonitrile-acrylic rubber-styrene (AAS) copolymers, and the like, and combinations thereof. As used herein, in the ABS resin, a copolymer (g-ABS) obtained by grafting a styrene monomer, which is an aromatic vinyl compound, and an acrylonitrile monomer, which is an unsaturated nitrile compound, to a core butadiene rubbery polymer can be dispersed as the graft copolymer in a styrene-acrylonitrile (SAN) copolymer as the aromatic vinyl copolymer.

Further, the rubber-modified aromatic vinyl copolymer may include the graft copolymer in an amount of about 10 wt % to about 100 wt %, for example about 15 wt % to about 90 wt %, and optionally the aromatic vinyl copolymer in an amount of about 90 wt % or less, for example about 10 wt % to about 85 wt %. In some embodiments, the rubber-modified aromatic vinyl copolymer may include the graft copolymer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %. Further, according to some embodiments of the present invention, the amount of the graft copolymer can be in a range from about any of the foregoing amounts to about any other of the foregoing amounts.

In some embodiments, the rubber-modified aromatic vinyl copolymer may include the aromatic vinyl copolymer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the aromatic vinyl copolymer can be in a range from about any of the foregoing amounts to about any other of the foregoing amounts.

When the rubber-modified aromatic vinyl copolymer includes the graft copolymer and the aromatic vinyl copolymer in an amount within the above ranges, the flame retardant thermoplastic resin composition can have an excellent balance of impact strength and mechanical properties.

Examples of the aromatic vinyl resin may include without limitation polystyrenes (PS), high-impact polystyrenes (HIPS), acrylonitrile-butadiene-styrene (ABS) copolymers, styrene-acrylonitrile (SAN) copolymers, acrylonitrile-styrene-acrylate (ASA) copolymers, and the like. These resins may be used alone or in combination thereof.

A polyphenylene ether resin and a rubber-modified aromatic vinyl resin having excellent compatibility may be used.

A method for preparing the aromatic vinyl resin is well known by those skilled in the art, and the resin can be commercially obtained.

For example, the aromatic vinyl resin may be polymerized by thermal polymerization without an initiator, or in the presence of an initiator. Examples of the polymerization initiator include without limitation peroxide initiators such as benzoyl peroxide, t-butyl hydroperoxide, acetyl peroxide, cumene hydroperoxide, and the like; and azo initiators such as azobisisobutyronitrile, without being limited thereto. These initiators may be used alone or in combination thereof.

The aromatic vinyl resin may be prepared by mass polymerization, suspension polymerization, emulsion polymerization, or combinations thereof. In exemplary embodiments, mass polymerization is used.

The aromatic vinyl resin may have a weight average molecular weight from about 10,000 g/mol to about 500,000 g/mol as measured by GPC (gel permeation chromatography), without being limited thereto.

Polyphenylene Ether Resin

The polyphenylene ether resin can be used to improve flame retardancy and heat resistance, and any polyphenylene ether resin typically used in flame retardant thermoplastic resin compositions may be employed. Examples of the polyphenylene ether resin include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, a copolymer of poly(2,6-dimethyl-1,4-phenylene)ether and poly(2,3,6-trimethyl-1,4-phenylene)ether, a copolymer of poly(2,6-dimethyl-1,4-phenylene)ether and poly(2,3,6-triethyl-1,4-phenylene)ether, and the like, and combinations thereof. In exemplary embodiments, poly(2,6-dimethyl-1,4-phenylene)ether and/or a copolymer of poly(2,6-dimethyl-1,4-phenylene)ether and poly(2,3,6-trimethyl-1,4-phenylene)ether can be used, for example, poly(2,6-dimethyl-1,4-phenylene)ether can be used.

Although the degree of polymerization of the polyphenylene ether resin is not particularly limited, a polyphenylene ether resin having an intrinsic viscosity from about 0.2 dl/g to about 0.8 dl/g, as measured in chloroform at 25° C., may be used in consideration of thermal stability, workability, and the like.

In exemplary embodiments, a polyphenylene ether resin and a rubber-modified aromatic vinyl resin having excellent compatibility may be used.

Polycarbonate Resin

The polycarbonate resin is a thermoplastic polycarbonate resin. As the polycarbonate resin, an aromatic polycarbonate resin prepared by, for example, reacting one or more diphenols (diol compounds), such as the compounds represented by Formula 4, with phosgene, a halogen formate, a carbonate diester or a combination thereof, may be used.

Examples of diphenols that can be used in the polycarbonate resin can include without limitation 4,4′-dihydroxydiphenyl, 2,2-bis-(4-hydroxyphenyl)-propane (also referred to as bisphenol-A), 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and combinations thereof. In exemplary embodiments, 2,2-bis-(4-hydroxyphenyl)-propane, 2,2-bis-(3,5-dichloro-4-hydroxyphenyl)-propane, and/or 1,1-bis-(4-hydroxyphenyl)-cyclohexane can be used, for example, 2,2-bis-(4-hydroxyphenyl)-propane can be used.

The polycarbonate resin may include a linear polycarbonate resin, such as a polycarbonate resin produced using bisphenol-A. Another example of the polycarbonate resin includes branched polycarbonate resin, which may be prepared by reacting one or more diphenols with about 0.05 mol % to about 2 mol % of a polyfunctional compound containing tri- or higher functional groups, for example, tri or higher-valent phenol groups, with respect to the total amount of diphenols used in polymerization.

The polycarbonate resin may be used in the form of a homo-polycarbonate resin, a co-polycarbonate resin, or blends thereof.

In addition, the polycarbonate resin may be partially or completely replaced by an aromatic polyester-carbonate resin obtained by polymerization in the presence of an ester precursor, for example, a bifunctional carboxylic acid.

The polycarbonate resin may have a weight average molecular weight (Mw) from about 10,000 g/mol to about 200,000 g/mol, for example, from about 15,000 g/mol to about 80,000, without being limited thereto.

The flame retardant thermoplastic resin composition according to the invention can exhibit excellent properties in terms of flame retardancy, heat resistance, and the like, and can have a good balance of various properties. When evaluated on a 1.2 mm thick specimen according to the UL-94 vertical flammability test method, the composition may have a flame retardancy level of V-0 or higher. In addition, the composition may have a Vicat softening temperature of about 100° C. to about 140° C., for example about 120° C. to about 130° C., as measured in accordance with ASTM D1525.

The flame retardant thermoplastic resin composition may further include one or more additives. Examples of the additives can include without limitation flame retardant aids, lubricants, plasticizers, heat stabilizers, anti-dripping agents, antioxidants, compatibilizers, photostabilizers, pigments, dyes, inorganic additives, and the like, as needed. These additives may be used alone or in combination thereof. For example, the additives may be present in an amount of about 0.1 parts by weight to about 10 parts by weight based on about 100 parts by weight of the thermoplastic resin, without being limited thereto.

The flame retardant thermoplastic resin composition may be prepared in pellet form by mixing the above components and other optional additives, followed by melt extrusion in an extruder. Various molded articles may be produced using the prepared pellets through various molding methods, such as injection molding, extrusion, vacuum molding, cast molding, and the like. These molding methods are well known by those skilled in the art.

Since the molded article according to the invention can exhibit excellent properties in terms of stiffness, flame retardancy, and the like, the molded article may be broadly applied to components of electric and electronic products, exterior materials, automobile parts, miscellaneous goods, structural materials, and the like.

Now, the present invention will be described in more detail with reference to some examples. However, it should be noted that these examples are provided for illustration only and are not to be construed in any way as limiting the present invention. A description of details apparent to those skilled in the art will be omitted for clarity.

### EXAMPLES

### Preparative Example 1

### Preparation of Phosphorous Copolymer

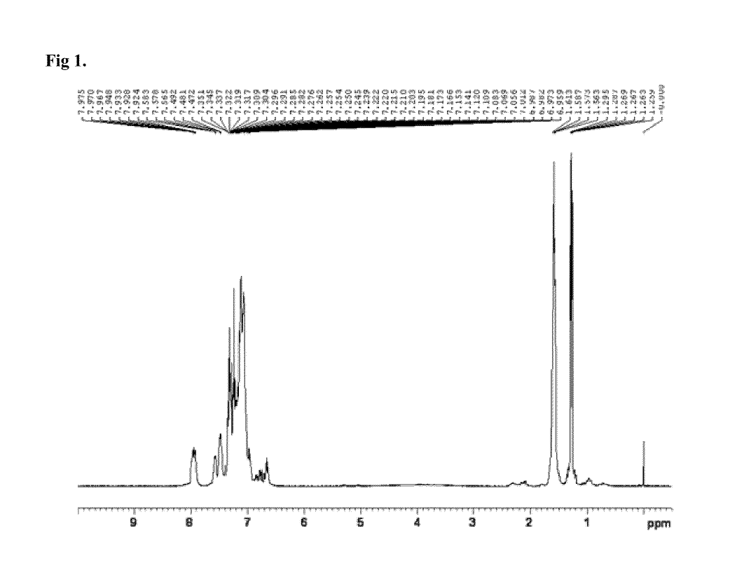

1.0 kg of 2,2-bis-(4-hydroxyphenyl)-propane and, as an end-capping agent, 0.2 kg of 4-t-butylphenol and 0.03 kg of aluminum chloride are added to 5 kg of chlorobenzene, followed by heating a mixture of the above components to 131° C. Then, reaction is started by dropwise addition of 0.5 kg of phenyl dichlorophosphate and 0.4 kg of phenylphosphonic dichloride to the mixture. After completion of addition, the resultant is additionally stirred for 8 hours, and then, the reaction is finished. After the reaction, the resultant is cooled to 80° C., washed with 6 kg of 10% hydrochloric acid, and washed twice with 6 kg of purified water. After removing the aqueous layer and removing the organic layer through reduced pressure distillation, 1.8 kg of a phosphorous copolymer is obtained (acid value: 0.3 KOH mg/g). An NMR spectrum of the prepared phosphorous copolymer is measured (300 MHz, Briker AVANCE III & Ultrashield Magnet Co., Ltd.), and results are shown in FIG. 1. A weight average molecular weight (Mw) and a number average molecular weight (Mn) of the prepared phosphorous copolymer are measured by GPC (gel permeation chromatography), and a PDI (Mw/Mn) value is calculated. In addition, to evaluate heat resistance, temperature of fast degradation, char yield (wt %) at 700° C. and glass transition temperature are measured using a TGA (METTLER TOLEDO) and a DSC (DSC Q100, TA Instruments). Measurement results are shown in Table 1.

TABLE 1

| | | | Evaluation of heat resistance | | |
|---|---|---|---|---|---|
| | | | Temperature | Char | |
| Molecular weight | | | of fast | yield at 700 | Glass transition |
| Mn | Mw | PDI | degradation | (wt %) | temperature |
| 1.5K | 2.4K | 1.7 | 350° C.~550° C. | 20 wt % | 82° C. |

From the results shown in Table 1, it can be seen that the phosphorous copolymer (Preparation Example 1) exhibits excellent heat resistance.

Details of components used in Examples and Comparative Examples are as follows:

(A) Aromatic vinyl resin

(A1) A rubber-modified styrene resin HG-1760S (HIPS, Cheil Industries Inc.) is used. The butadiene rubber (rubbery polymer) has an average particle diameter of 1.5 μm and is present in an amount of 6.5 wt %.

(A2) A rubber-modified styrene resin CHT (Cheil Industries Inc.) is used. Here, the butadiene rubber (rubbery polymer) has an average particle diameter of 0.26 μm and was present in an amount of 58 wt %.

(B) Polyphenylene ether resin

A poly(2,6-dimethyl-phenyl ether), S-202 (Asahi Kasei Co., Ltd., Japan) is used. The resin has an average particle diameter of tens of micrometers and is in powder form.

(C) Polycarbonate resin

A bisphenol-A type polycarbonate PANLITE L-1250W (Teijin Co., Ltd., Japan) was used. The resin has a weight average molecular weight of 25,000 g/mol.

(D) Phosphorous copolymer

The phosphorous copolymer prepared in Preparation Example 1 is used.

(E) Phosphorous compound (monomolecular type)

(E1) CR-741S (Daihachi Co., Ltd., Japan) is used.

(E2) PX-200 (Daihachi Co., Ltd., Japan) is used.

(F) Phosphorous polymer

A polyphosphonate, prepared by polymerizing 2,2-bis-(4-hydroxyphenyl)-propane, phenylphosphonic dichloride and 4-tert-butyl phenol as an end-capping agent, is used. The polymer has a weight average molecular weight (Mw) of 2,600 g/mol.

### Examples 1 to 3 and Comparative Examples 1 to 8

After placing these components in amounts as listed in Tables 2 and 3 in a reactor, pellets are prepared by melting, kneading and extruding a mixture thereof. Here, a twin-screw extruder having a diameter of 45 mm and an L/D value of 29 (L/D=29) is used. After dehydrating the prepared pellets at 70° C. for 2 hours, specimens are prepared by injection molding using a 6 oz injection machine (molding temperature: 180° C. to 280° C., mold temperature: 40° C. to 80° C.). The prepared specimens are evaluated by the following methods, and results are shown in Tables 2 and 3.

Evaluation of Properties

(1) Flame retardancy and burning time: Flame retardancy and burning time are measured on each of ⅛″ thick, 2.0 mm thick and 1.5 mm thick specimens according to the UL-94 vertical flammability test method.

(2) Izod impact strength (unit: kgf·cm/cm): Izod impact strength is measured on a ⅛″ thick notched Izod specimen in accordance with ASTM D256.

(3) Heat resistance (Vicat softening temperature: VST, unit: ° C.): Vicat softening point is measured under a load of 5 kgf in accordance with ASTM D1525.

(4) Heat deflection temperature (unit: ° C.): Heat deflection temperature is measured under a surface pressure of 1.82 MPa in accordance with ASTM D648.

TABLE 2

| | Example | | Comparative Example | | | | | |
|---|---|---|---|---|---|---|---|---|
| | 1 | 2 | 1 | 2 | 3 | 4 | 5 | 6 |
| (A1) (wt %) | 55 | 55 | 55 | 55 | 55 | 55 | 55 | 55 |
| (B) (wt %) | 45 | 45 | 45 | 45 | 45 | 45 | 45 | 45 |
| (D) (parts by | 15 | 20 | — | — | — | — | — | — |
| weight) | | | | | | | | |
| (E1) (parts by | — | — | 15 | 20 | — | — | — | — |
| weight) | | | | | | | | |
| (E2) (parts by | — | — | — | — | 15 | 20 | — | — |
| weight) | | | | | | | | |
| (F) (parts by | — | — | — | — | — | — | 15 | 20 |
| weight) | | | | | | | | |
| Flame Retardancy | V-0/ | V-0/ | V-1/ | Fail | V-1/ | V-1/ | V-1/ | V-1/ |
| (⅛″)/Total | 47 | 38 | 107 | | 67 | 54 | 70 | 55 |
| burning time | seconds | seconds | seconds | | seconds | seconds | seconds | seconds |
| Heat resistance | 131 | 128 | 103 | 104 | 106 | 98 | 129 | 125 |
| (VST, ° C.) | | | | | | | | |
| Heat deflection | 115 | 112 | 90 | 89 | 91 | 83 | 110 | 109 |
| temperature (° C.) | | | | | | | | |

TABLE 3

| | | | Comparative | |
|---|---|---|---|---|
| | | Example | Example | |
| | | 3 | 7 | 8 |
| (A2) (wt %) | | 20 | 20 | 20 |
| (C) (wt %) | | 80 | 80 | 80 |
| (D) (parts by weight) | | 16.5 | — | — |
| (E1) (parts by weight) | | — | 16 | — |
| (E2) (parts by weight) | | — | 0.5 | — |
| (F) (parts by weight) | | — | — | 16.5 |
| Flame | 2.0 mm | V-0/10 seconds | V-0/13 seconds | V-0/16 seconds |
| Retardancy/ | 1.5 mm | V-0/24 seconds | V-0/36 seconds | V-1/55 seconds |
| Total | | | | |
| burning | | | | |
| time | | | | |

| | | | |
|---|---|---|---|
| Heat resistance (VST,) | 116 | 92 | 107 |
| Izod impact strength | 62 | 60 | 59 |

From the results shown in Table 2, it can be seen that the flame retardant thermoplastic resin compositions prepared in Examples 1 and 2, employing a polystyrene resin, a polyphenylene ether resin and the phosphorous copolymer according to the invention, exhibit excellent heat resistance while maintaining excellent flame retardancy. In contrast, the flame retardant thermoplastic resin compositions prepared in Comparative Examples 1 to 6, employing a monomolecular type phosphorous compound or a polyphosphonate (phosphorous polymer) as a flame retardant, exhibit property deterioration in terms of flame retardancy and heat resistance, as compared with the compositions prepared in Examples.

In addition, from the results shown in Table 3, it can be seen that the flame retardant thermoplastic resin composition prepared in Example 3, employing a polycarbonate resin, a polystyrene resin (rubber-modified graft copolymer) and the phosphorous copolymer according to the invention, exhibit excellent heat resistance while maintaining excellent flame retardancy. In contrast, it can be seen that the flame retardant thermoplastic resin composition prepared in Comparative Example 7, employing a monomolecular type phosphorous compound as the flame retardant, exhibits similar flame retardancy to the composition in Example 3, but deteriorated heat resistance. Further, in the flame retardant thermoplastic resin composition of Comparative Example 8, employing a polyphosphonate (phosphorous polymer), flame retardancy is deteriorated to a level of V-1 and burning time is deteriorated.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A phosphorous copolymer comprising a repeat unit represented by Formula 1: 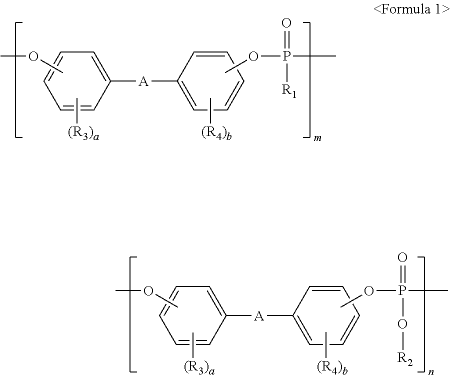
wherein:
each A is the same or different and is each independently a single bond, C₁ to C₅ alkylene, C₁ to C₅ alkylidene, C₅ to C₆ cycloalkylidene, —S—, or —SO₂—;
R₁ and R₂ are the same or different and are each independently substituted or unsubstituted C₁ to C₆ alkyl or substituted or unsubstituted C₆ to C₂₀ aryl;
R₃ and R₄ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen;
a and b are the same or different and are each independently an integer from 0 to 4; and
m and n are the same or different and are each independently an integer from 1 to 500.

2. The phosphorous copolymer according to claim 1, wherein a ratio of the m repeat units to the n repeat units (m:n) is about 1: about 0.1 to about 1: about 10.

3. The phosphorous copolymer according to claim 1, wherein the phosphorous copolymer has a weight average molecular weight from about 1,000 g/mol to about 50,000 g/mol.

4. The phosphorous copolymer according to claim 1, wherein the phosphorous copolymer has a glass transition temperature from about 60° C. to about 200° C.

5. A method for preparing a phosphorous copolymer comprising a repeat unit represented by Formula 1, the method comprising: reacting a phosphonic dichloride compound represented by Formula 2, a dichlorophosphate compound represented by Formula 3, and a diol compound represented by Formula 4. 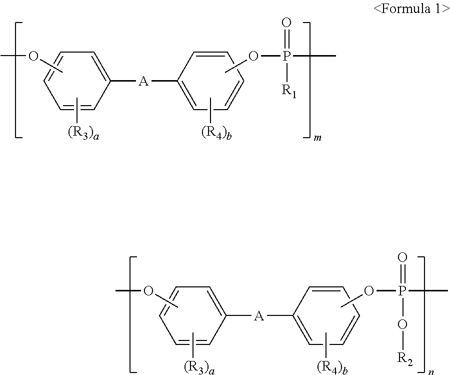
wherein:
each A is the same or different and is each independently a single bond, C₁ to C₅ alkylene, C₁ to C₅ alkylidene, C₅ to C₆ cycloalkylidene, —S—, or —SO₂—;
R₁ and R₂ are the same or different and are each independently substituted or unsubstituted C₁ to C₆ alkyl or substituted or unsubstituted C₆ to C₂₀ aryl;
R₃ and R₄ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen;
a and b are the same or different and are each independently an integer from 0 to 4; and
m and n are the same or different and are each independently an integer from 1 to 500. 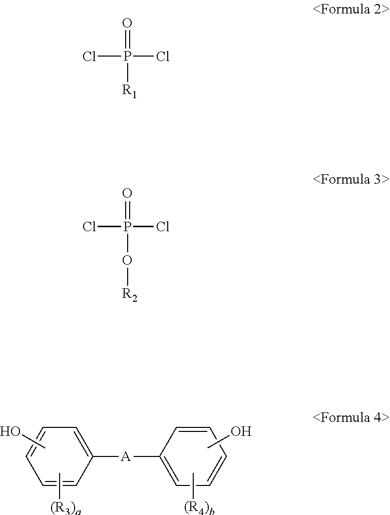
wherein in Formulas 2 to 4, A, R₁, R₂, R₃, R₄, a and b are the same as defined in Formula 1.

6. The method according to claim 5, wherein about 1 weight equivalent of the phosphonic dichloride compound represented by Formula 2 and the dichlorophosphate compound represented by Formula 3 is reacted with about 0.5 weight equivalents to about 2 weight equivalents of the diol compound represented by Formula 4.

7. The method according to claim 5, wherein a molar ratio of the phosphonic dichloride compound represented by Formula 2 to the dichlorophosphate compound represented by Formula 3 is about 1: about 0.1 to about 1: about 10.

8. The flame retardant thermoplastic resin composition comprising:
a thermoplastic resin; and
a phosphorous copolymer comprising a repeat unit represented by Formula 1: 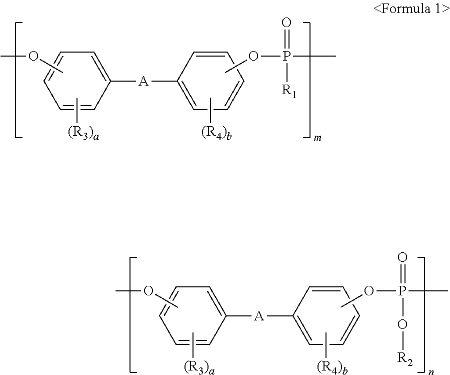
wherein:
each A is the same or different and is each independently a single bond, C₁ to C₅ alkylene, C₁ to C₅ alkylidene, C₅ to C₆ cycloalkylidene, —S—, or —SO₂—;
R₁ and R₂ are the same or different and are each independently substituted or unsubstituted C₁ to C₆ alkyl or substituted or unsubstituted C₆ to C₂₀ aryl;
R₃ and R₄ are the same or different and are each independently substituted or unsubstituted C₁ to C₆ alkyl, substituted or unsubstituted C₃ to C₆ cycloalkyl, substituted or unsubstituted C₆ to C₁₂ aryl, or halogen;
a and b are the same or different and are each independently an integer from 0 to 4; and
m and n are the same or different and are each independently an integer from 1 to 500.

9. The thermoplastic resin composition according to claim 8, comprising the phosphorous copolymer in an amount of about 0.1 parts by weight to about 40 parts by weight based on about 100 parts by weight of the thermoplastic resin.

10. The thermoplastic resin composition according to claim 8, wherein the thermoplastic resin comprises an aromatic vinyl resin, polyphenylene ether resin, polycarbonate resin, acrylic resin, polyamide resin, polyolefin resin, or a combination thereof.

11. The thermoplastic resin composition according to claim 10, wherein the thermoplastic resin comprises about 50 wt % to about 99 wt % of the aromatic vinyl resin, and about 1 wt % to about 50 wt % of the polyphenylene ether resin.

12. The thermoplastic resin composition according to claim 10, wherein the thermoplastic resin comprises about 5 wt % to about 95 wt % of the polycarbonate resin, and about 5 wt % to about 95 wt % of the aromatic vinyl resin.

13. The thermoplastic resin composition according to claim 12, wherein the aromatic vinyl resin is a rubber-modified aromatic vinyl resin.

14. The thermoplastic resin composition according to claim 8, further comprising at least additive comprising a flame retardant aid, lubricant, plasticizer, heat stabilizer, anti-dripping agent, antioxidant, compatibilizer, photostabilizer, pigment, and dyes, or a combination thereof.

15. The thermoplastic resin composition according to claim 8, wherein the thermoplastic resin composition has a flame retardancy level of V-0 or higher, as measured according to the UL-94 vertical flammability test method, and a Vicat softening temperature (VST) from about 100° C. to about 140° C.

16. A molded article formed of the flame retardant thermoplastic resin composition according to claim 8.
